(19) United States
(12) Patent Application Publication
(10) Pub. No.: US 2006/0147884 A1
(43) Pub. Date: Jul. 6, 2006

(54) Psychometric instruments and methods for mood analysis, psychoeducation, mood health promotion, mood health maintenance and mood disorder therapy

(76) Inventor: Anthony Durrell, New South Wales (AU)

Correspondence Address: HUTCHISON LAW GROUP PLLC, PO BOX 31686, RALEIGH, NC, 27612, US

(21) Appl. No.: 10/529,016

(22) PCT Filed: Sep. 26, 2003
(86) PCT No.: PCT/AU03/01272

§ 371 Date: Nov. 4, 2005

(30) Foreign Application Priority Data
Sep. 26, 2002 (AU) 2002951772

(51) Int. Cl. G09B 19/00

(52) U.S. Cl. 434/236

(57) ABSTRACT

A system and method that allows a person to comprehensively and non-verbally express their present, past and anticipated future emotional responses regarding all aspects of their life including relationships, work, study, memories and experiences. The system relies on a method wherein the person can graphically represent their mood state by depicting the proportion that each of a number of primary moods contributes to the mood state for any nominated aspect of their life. The system provides some guidance regarding healthy and unhealthy mixes of these primary moods thereby allowing early identification of vulnerable mood states which without intervention may progress to mood disorders. In a clinical setting, the invention may be valuable in monitoring treatment response, sub-typing mood related diagnoses, measuring therapist-patient empathy, establishing treatment goals and as a therapeutic tool in emotionally focussed psychotherapy. The method can be performed using and electronic device, such as a computer, running appropriate software.

### FIELD OF THE INVENTION

The present invention relates to a method of displaying, diagnosing, sub-typing and analysing both healthy and unhealthy emotional or mood states of a person and a system for use in the method. The present invention also provides a user of the method and/or system with an emotional education that can assist in helping them to identify, plan and maintain healthy moods.

### BACKGROUND OF THE INVENTION

Mood is generally understood to be the prevailing tone or feeling of a person. Many terms are used to describe mood with common terms such as “Happy”, “Sad”, “Anger” and “Fear” being just some of the terms used by persons to describe their mood.

It is normal to have changes of mood and even occasional episodes of extreme happiness, sadness, anger and fear. However, sustained bouts of extremes of emotion are disabling for the person and often give rise to disordered thinking patterns and unhealthy behaviours. In contrast, healthy emotional balance allows a person's thoughts, intellectual potential, intuition and awareness to flow more freely.

A person can be considered to be suffering a mood disorder, which is also known as an affective disorder, if their moods are characterised by sustained extremes in both intensity and/or type. Even intense symptoms of affective disorders are often misinterpreted as merely mood swings and unfortunately affective disorders are sometimes confused by some as personality flaws rather than a real medical condition. For example, chronic sadness can lead to depression while extreme swings between elation and sadness is often considered indicative of manic depression or bipolar disorder. Extreme levels of fear can lead to panic attacks while extreme anger can lead to rage and outbreaks of violent behaviour by the person.

It has been suggested that depression and bipolar disorders strike one in seven of the population and that somewhere between 7-14% of children will experience an episode of major depression before the age of 15. The World Health Organisation has also recognised mood disorders as a significant source of morbidity and mortality, particularly in western countries.

Children and adults with mood disorders often do not cope well in society. When depressed, persons can experience a loss of interest and lack of enjoyment in life, while for a person with bipolar disorder, the manic swings can create a disruptive influence on aspects of their life and the lives of those around them.

Despite these statistics, there is still little done to promote mental health education, mental health awareness, mental illness destigmatisation and mental illness education.

Mood disorders, such as depression, are generally diagnosed by physicians through consultation and use of questions, questionnaires and checklists. While useful, such approaches generally rely on verbal expression. This can be problematic as the individual may not be able to clearly express their thoughts and feelings in words. This is particularly the case for children, the developmentally delayed, and sufferers of dyslexia and autism.

One example of an apparatus that allows individuals to express their mood in a non-verbal manner is described in U.S. Pat. No. 5,511,981 (Olsen). This patent describes use of a structure that can receive various removably securable elements that are indicators of symptoms the individual is experiencing or feeling. The structure can have a visual element, such as a depiction of a tree that is divided into areas representative of different moods. For example, the top area of the tree can be the “mania or high region”, the middle area can be the “okay region” and the bottom area is the “depression or low region”. The person attached the elements to the tree in the locations representative of their mood. The tree can then be studied by a physician looking for clues as to the actual mood state of the person. While providing a non-verbal manner of communicating or indicating mood, the apparatus is quite restricted in use and does not provide a system for monitoring changes in mood over time.

An example of a system that allows individuals to chart their mood over time is described in U.S. Pat. No. 6,607,390 (Glenn and Whybrow). The system relies on use of a program running on a computer and allows an individual to enter their daily mood and other clinical data. This system relies on the individual entering a number between 0 and 100 on a visual analogue scale (VAS) that is indicative of their mood over say, the previous 24 hours. The most extreme feelings of depression and mania the individual has ever experienced define the anchor points of this scale. While providing individuals with a means of graphically representing their mood, this system does not rely on anything but a subjective analysis by the individual of their overall mood state and does not provide a breakdown of the various feelings and emotions of the individual that have caused that mood determination by the individual.

The present invention is directed to a method and/or system that preferably does not suffer at least some of the deficiencies of the prior art.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The present invention is depicted to a method that preferably allows an individual to express and monitor their moods and preferably provide insights into their mood beyond that provided by the prior art. This invention also preferably provides a comprehensive, yet simple, qualitative and quantitative mood rating system. The invention also preferably provides a colourful, visuo-spatial and non-verbal form of mood expression.

The present inventor proposes a “Quaternary Mood Theory” (QMT) in which four so-called primary moods combine in various combinations to generate a multitude of so-called secondary moods. These secondary moods generally reflect the overall emotional state of a person. Thus, this Quaternary Mood Theory can be considered in some ways as analogous to colour theory which identifies three primary colours which in various proportions mix to generate all colours. For the purposes of the theory, the inventor terms these primary moods as happy, sad, fear and anger. Other terms than these but which convey the same general sense can be envisaged and are referred to below.

Fear in small amounts is very healthy and can serve as a source of protection from danger. Unfortunately, many people do not like to express fear as this mood has been stigmatised with negative connotations. Of course, too much fear is unhealthy and leads to panic attacks, anxiety disorders and avoidant behaviour.

Anger in small amounts is also very healthy and encourages a person to defend themself, assert an opinion and protect loved ones. Like fear, anger is stigmatised and is generally viewed as a destructive mood state. This is despite the fact that appropriate levels of anger can be energising, motivating and liberating. Excessive anger is of course unhealthy as it can lead to rage and damaging or abusive behaviours.

The “Flight or Fight” response is a well recognised primitive survival brain reflex which involves these two abovementioned primary moods of fear and anger respectively.

Sad feelings in moderate amounts, contrary to the stigma, are also very healthy emotional states. Times of sadness can promote problem solving, self-reflection, tolerance and maturation. Excessive sadness is however unhealthy and can result in depression.

Modern society places much emphasis on happiness. While happy feelings in moderate amounts are healthy in that they promote relaxation, laughter and optimism, happy moods need to be present in a healthy blend with the other primary moods of fear, anger, and sad. If happy moods are present in excessive proportions this can lead to the unhealthy mood disorder known as mania.

A person's mood state will typically be a secondary mood state that is based on some combination or blend of these four primary moods. Thus this “Quaternary Mood Theory”, has the potential to provide an integrated and relatively simple approach to understanding mood health and mood disorders.

The inventor proposes that the neuroanatomical architecture of the bihemispheric and symmetrical human brain supports this model. Clinical and research observations from Transcranial Magnetic Stimulation and Deep Brain Stimulation studies support a relationship between neural polarisation and emotional state. Moreover, clinical experience and observation supports the Quaternary division of basic mood states given that four qualitatively distinct extremes of Emotion are already well recognised, being “Mania”, “Depression”, “Rage”, and “Panic”.

The inventor further proposes that the optimal baseline primary mood mix (PMM) is present when the approximate ratio of fear:anger:sad:happy is in the order of a ratio of 1:2:3:4 respectively. Clearly such a ratio is not possible or appropriate at all times. However, this “ideal” primary mood mix (PMM) does provide a baseline primary mood mix goal. The inventor notes from his clinical experience that as a person's primary mood mix diverges further from this 1:2:3:4 ratio the person is less able to utilize their intellect. Moreover, the risk of a person developing a Mood Disorder increases as the PMM shifts away from this ideal PMM. If any one of the primary moods occupies more than 50% of the total PMM ratio for a sustained period, then that person is at heightened risk of developing a Mood Disorder.

The present invention is directed to a method and tool for graphically presenting the mood state of a person. The method and tool then can be used to determine, monitor, analyse and/or treat the mood of the person and allow the person to set mood goals. The method can advantageously be used on children and adolescents, to provide a method of determining the current mood state. Also, the mood state pertaining to all manner of foci can be created by thinking about a specific past, present or anticipated event, person or persons, or thing. In particular, it provides a technique for looking beyond what might be called the secondary mood state being experienced by the person and attempts to break that secondary mood down into its mix of component primary moods. It is proposed by the inventor that over time an individual can improve their mood reflection skills or emotional insight by the repeated process of identifying their various mixtures of the four primary moods underlying any given secondary mood state.

By being aware of their current mood state or the mood state caused by thinking about a particular foci, by determining triggers for mood state change, and by monitoring changes in mood state over time, the present invention preferably provides the person or their consulting physician with insights into how to identify, treat, modify and/or handle moods before they transform into serious psychiatric disorders, such as depression or bipolar disorder. Moreover, Mood Goals are able to be graphically established utilising the present invention.

The present inventor has coined the term “Emotional Behavioural Therapy” (EBT) to describe the potential treatment offered by the present invention. In this EBT form of therapy, the patient is encouraged to examine past memories and consider the associated mixture of moods that accompany that memory being examined. Those memories which are accompanied by, or evoke, a healthy primary mood mix (PMM) are considered resolved and stable. However, those memories associated with, or evoking, an unhealthy blend of PMM are considered unresolved and unstable.

In contrast to other forms of psychotherapy such as Cognitive Behavioural Therapy (CBT) which primarily focuses on improving the mixture of healthy and unhealthy thoughts, this invention directs the examination towards the healthy and unhealthy mixture of primary moods. Thus, the primary focus of EBT is mood related with change being directed towards improving the person's PMM related to various memories in their life. The inventor utilises an analogy between the “bricks and mortar of a wall” and the “memories and moods of a mind” in EBT. In this analogy, the bricks represent memories while the emotional response to each memory is symbolised by the mortar surrounding each brick. Like mortar which can be strong or weak depending on the mixture of its four ingredients, the emotional response to memories can afford strength or weakness to our mind depending on the PMM. The abovementioned ideal PMM of 1:2:3:4 provides the greatest strength of “mortar” and secures memories into stable positions within the “brick wall” of the mind.

The present invention can be used by the person alone or in consultation with a physician. The invention can be utilised to measure the level of emotional empathy between a Doctor and patient by comparing separately formed data sets from the Doctor and patient.

In one aspect, the present invention is a method of graphically representing a selected mood state of a person, the method comprising the steps of:

(a) presenting a graphical representation means to the person; and

(b) having the person use the graphical representation means to graphically represent the proportion that each of a number of primary moods contributes to the selected mood state.

In a further embodiment, the method further comprises a step of:

(c) displaying the result of the graphical representation.

According to a second aspect, the present invention is a system for graphically representing a selected mood-state of a person, the system comprising:

a graphical representation means for graphically representing the proportion that each of a number of primary moods contributes to their selected mood state.

In one embodiment, the graphical representation means of the first aspect or the system of the second aspect can comprise an electronic device. Such a device can allow use by a person of colour and/or dimension to graphically represent the proportion that said each of a number of primary moods contributes to said selected mood state. The device can be used by the person alone or in combination with input received from a physician. The inventor has coined the tern “mood tool” for the various devices that can be used by the person to graphically represent the proportion that said each of a number of primary moods contributes to the selected mood state.

In this embodiment, the electronic device can be selected from the group comprising a desktop computer, a laptop computer, a notebook type computer, a personal organiser, a handheld game device, and a cellular or mobile telephone. The electronic device can also be solely designed for use in the method according to the present invention.

In one embodiment, the electronic device preferably has a microprocessor, a visual display device, and an input device. In a further embodiment, the device preferably has a data storage device.

The electronic device preferably relies on use of software instructions or programme code to run a programme on the device that allows a person to graphically represent the said selected mood state.

In one embodiment, the programme code can, on execution, result in the electronic device requiring the person to input identification details before proceeding. For example, the electronic device can be caused to display an Identifier Menu, which the person utilises to input data such as their name, address, age, etc. These details can be stored in the data storage device of the electronic device and used to ensure that the person is only able to access their data and/or allow later comparison of that particular person's mood state as determined at different times by use of the method as defined herein.

In a further embodiment, the programme code can, on execution, result in the device displaying a Select Menu which allows the person to select which of a plurality of colours is representative to them of a particular primary mood. The Select Menu can comprise the electronic device displaying a plurality of blocks of different colour on the visual display device. These colours can include red, blue, yellow, green, black, and orange. Other suitable colours can be envisaged. The person then selects a colour from those presented for each of the primary moods. In one embodiment, the blocks of colour can comprise coloured dots depicted on a screen. A question or request can also be displayed on the screen. In addition to or instead of this, the question or request can be output through a set of speakers or earphones to the person. The question or request would be repeated each time for each of the primary moods.

The person will normally be asked to assign a colour to a primary mood. Typically, the person will be asked to assign a colour to four primary moods. In the case of children, the primary moods mentioned might be “Fear”, “Anger”, “Sad” and “Happy”. In the case of adults, the four primary moods may be presented in the same way or as “Caution”, “Assertion or Courage”, “Reflection or Solving-time” and “Delight or Solved-time”. Other representative terms can be envisaged.

It is generally regarded that there is no correct colour to identify these primary moods. The method does though allow the person to select which colour is representative of which primary mood. Changes in the selection of colour for a particular primary mood may be noted by the physician and used to monitor changes in mood state.

Use of the electronic device can allow the following questions to be displayed:

Choose your colour for “Fear” (or “Assertion”).

Choose your colour for “Anger” (or “Caution”).

Choose your colour for “Sad” (or “Reflection”).

Choose your colour for “Happy” (or “Delight”).

Prior to or after displaying these requests, the electronic device or the consulting physician might ask the person to think about or focus on their current mood state or instead think or focus on a particular subject. This step is coined “mood-focus” by the present inventor. In the case of an electronic device, the device might have a Focus Menu which allows the person to select their subject from a number of presented options. For example, the subjects presented to the person might include:

Myself

Family

Friends

Work

School

Other.

Where the person chooses “Myself”, the person can be presented with a sub-menu of subjects. For example, the subjects presented in the sub-menu might include:

My Looks

My Thoughts

My Weight

My Personality

My Habits

Other

Where the person chooses one of these subjects, the person can be presented with a still further sub-menu of subjects. For example, the person in selecting “My Looks” might be presented with the following list of foci:

How I now feel about my looks.

How I used to feel about my looks.

How I would like to feel about my looks.

Similar statements might be presented for each of the subjects in the sub-menu. Where the person chooses “Other”, the programme would preferably allow the person to enter the subject that is person is proposing to focus on.

Where the person chooses “Family”, the person can be presented with a sub-menu of subjects. For example, the subjects presented in the sub-menu might include:

Mother

Father

Brother

Sister

Children

Other

Where the person chooses one of these subjects, the person can be presented with a still further sub-menu of subjects. For example, the person in selecting “Mother” might be presented with the following list of foci:

How I now feel about my mother.

How I used to feel about my mother.

How I would like to feel about my mother.

Similar statements might be presented for each of the subjects in the sub-menu.

Where the person chooses “Friends”, the person can be presented with a sub-menu of subjects. For example, the subjects presented in the sub-menu might include:

Boyfriend

Girlfriend

Other

Where the person chooses one of these subjects, the person can be presented with a still further sub-menu of subjects. For example, the person in selecting “Boyfriend” might be presented with the following list of foci:

How I now feel about my boyfriend.

How I used to feel about my boyfriend.

How I would like to feel about my boyfriend.

Similar statements might be presented for each of the subjects in the sub-menu.

Where the person chooses “Work”, the person can be presented with a sub-menu of subjects. For example, the subjects presented in the sub-menu might include:

Boss

Workmates

Customers

Workload

Holidays

Sick leave

Other

Where the person chooses one of these subjects, the person can be presented with a still further sub-menu of subjects. For example, the person in selecting “Boss” might be presented with the following list of foci:

How I now feel about my boss.

How I used to feel about my boss.

How I would like to feel about my boss.

Similar statements might be presented for each of the subjects in the sub-menu.

Where the person chooses “School”, the person can be presented with a sub-menu of subjects. For example, the subjects presented in the sub-menu might include:

School work

Homework

School friends

Teacher

School bully

Examinations

Other

Where the person chooses one of these subjects, the person can be presented with a still further sub-menu of subjects. For example, the person in selecting “School work” might be presented with the following list of foci:

How I now feel about my school work.

How I used to feel about my school work.

How I would like to feel about my school work.

Similar statements might be presented for each of the subjects in the sub-menu.

If desired, the particular subject might be entered into the electronic device using the input device and stored in the data storage device for later retrieval or comparison with other tests.

In this aspect, the input device might comprise a keyboard, a keypad, a mouse, a joystick, a stylus, a touch screen, or any other device used to input data into an electronic device.

A number of techniques or mood tools can be used to graphically represent the proportion that the person considers a primary mood contributes to the selected mood state.

For example, once the colours for each primary mood have been selected, the programme code can then result in the electronic device displaying a graphical input screen that allows the person to graphically represent the proportion that each primary mood contributes to the selected mood state.

In one embodiment, the graphical input screen can comprise a shape of pre-defined area that is able to be coloured in by the person using the input device. In one embodiment, the person selects a first primary mood and then the person fills a portion of that area that is representative of the proportion that the person considers that primary mood represented by that colour contributes to the selected mood state.

For example, a child that enjoys school may choose to fill a significant portion of the pre-defined area with a colour that has been selected by that child as representative of the primary mood “Happy”, with much less of the area coloured in with the colour selected for the primary mood state of “Sad”, “Anger” or “Fear”. For a child that does not enjoy school or is experiencing bullying at school, the reverse may be expected. This process can be repeated for each of the primary moods until the pre-defined area is full. While each shape will typically be filled with four different colours in various proportions, it will be appreciated that the person may wish to choose less than four colours if they believe that one or more of the primary moods do not at all contribute to the selected mood state. This will be noted by the clinician and the person will be encouraged to choose four colours and generate a very small segment for that primary mood they feel is seemingly absent. For example, a person may not be able to identify any “happy” primary mood when focussing on a tragic event but with encouragement they will be able to feel some small degree of “happy” feelings that the tragedy is now in the past, has not recurred and was not worse.

The process of colouring in a proportion of the shape can be achieved through use of a stylus and a touch screen or a pointer clicking on a screen icon. Where a stylus and touch screen is used, the touch screen of the computer recognises the location of the stylus and colours in the shape on the screen in accordance with the movements of the stylus by the person.

In one embodiment, the predefined area can be a circle. Other shapes can, however, be envisaged. A circle is, however, preferred as the person can be asked to colour in the circle in a manner that results in the circle looking like a pie chart. This pie-chart, or “mood-pie” as coined by the present inventor, provides a graphical representation of mood state. Changes in the mood-pie over time also provide a means of assessing changes in mood state.

The process can be repeated on one or more occasions over a period of time. The period of time might constitute minutes, hours, days, weeks, months or even years. The person can choose or be asked to think about or mood-focus on the same subject each time they undergo the method and colour in a mood-pie representative of the primary moods. The various mood-pies can be stored in the storage device for later retrieval and/or comparison with other tests. In one embodiment, the device might allow playback of the various stored mood-pies over time. This allows longitudinal analysis of the mood state and any changes in the mood-pie over the period of time may be used as a guide to understanding the change in mood state of the person over that period of time.

In another embodiment, the mood tool can be a graphical input screen that displays of one or more Cartesian planes (or xy planes) that allow the person to plot points for each of the primary moods.

For example, the person may be asked to assign a number on a scale, such as between 0 and 10, that is representative of the degree to which a primary mood is representative of their feelings about said selected mood state. This may be repeated for each of the four primary moods defined herein.

The numbers chosen by the person are preferably plotted on the axes of the Cartesian plane. In one embodiment, the positive side of the y-axis can be representative of “Happy” (or “Delight”) while the negative side of the y-axis is representative of “Sad” (or “Reflection”). The positive side of the x-axis can be representative of the primary mood “Fear” (or “Caution”) while the negative side of the x-axis can be representative of “Anger” (or “Assertion”). The use of the axes of the Cartesian plane in other combinations can be envisaged. For example, the primary moods “Happy” and “Sad” can instead be plotted on the x-axis while the primary moods “Fear” and “Anger” can be plotted on the y-axis.

In these embodiments, the person in focussing on a particular subject can select a number on a scale, such as between 0 and 10, for each primary mood and this number can be plotted on the axes of the Cartesian plane. In a preferred embodiment, and where the person is using the electronic device as defined herein, the person can enter the number and this is then plotted on the Cartesian plane by the device. In one embodiment, a coloured line can be drawn from the origin of the Cartesian plane to the plot. Again, where used, this is preferably performed by the electronic device. The colour of this line is preferably selected by the person as being representative of that mood state. This process can be repeated for each of the primary moods. The result is four coloured lines of individual length extending from the origin of the Cartesian plane. This set of four lines, or “mood-compass” as coined by the present inventor, presents in graphical form the mood state of the person.

As with the mood-pie described above, the process can be repeated on one or more occasions over a period of time, with the period of time constituting minutes, hours, days, weeks, months or even years. Preferably, the person is asked to think about or mood-focus on the same subject each time and plot their primary moods and form a mood-compass. Any changes in the mood-compass over the period of time may be used as a guide to understanding the change in mood state of the person over that period of time.

It will be appreciated that in forming the mood-compass, the number does not need to be between 0 and 10 and can instead be between any two numbers. In another embodiment, for example, the person may select a number between 0 and 100.

In one embodiment, the plots made on the Cartesian plane can be used to form a quadrangle that is formed by joining the plots made on the Cartesian plane. This four-sided figure, or “mood-quadrangle” as coined by the present inventor, presents in graphical form the mood state of the person. As with the mood-pie described above, the process can be repeated on one or more occasions over a period of time, with the period of time constituting minutes, hours, days, weeks, months or even years. Preferably, the person is asked to think about or mood-focus on the same subject each time and plot their primary moods and form a mood-quadrangle. Any changes in the mood-quadrangle (eg. shape and/or area) over the period of time may be used as a guide to understanding the change in mood state of the person over that period of time.

In a still further embodiment, the graphical representation can be plotted on a Cartesian space (or xyz-space) instead of just a Cartesian plane. In this regard, one or two of the primary moods may be plotted on a z axis of the Cartesian space. This has the potential of allowing the person to form three-dimensional representations of their mood state or a “mood-space”. As with the mood-pie described above, the process can be repeated on one or more occasions over a period of time, with the period of time constituting minutes, hours, days, weeks, months or even years. Preferably, the person is asked to think about or mood-focus on the same subject each time and plot their primary moods on the Cartesian space. Any changes in the shape of the three-dimensional representation over the period of time may be used as a guide to understanding the change in mood state of the person over that period of time.

Where the person is using an electronic device, the computer can automatically generate a mood-quadrangle or mood-space on completion of the mood-compass by the person. The mood-compass, mood-quadrangle, or mood-space can be stored in the storage device for later review and/or comparison with other tests.

In a still further embodiment, the person can be presented with a mood tool wherein the person is presented with a set of coloured rings of varying diameters. In using these rings, the person can select a ring colour representative of a particular primary mood and then select from a range of sizes a ring of a particular diameter representative of the degree to which a primary mood is representative of their feelings about said subject. Generally, the greater the proportion a primary mood is representative of their feelings about said subject, the larger the ring diameter.

In a preferred embodiment, the person will be instructed to put together the set of concentric rings by starting with what they regard as their predominant primary mood about said subject and then work inwardly placing smaller diameter rings representative of the other primary moods within the firstly selected largest ring to form a graphical representation of their mood state. The rings, or “mood-rings” as coined by the present inventor, once put together provide a graphical representation of the mood state of the person.

As with the mood-pie described above, the process can be repeated on one or more occasions over a period of time, with the period of time constituting minutes, hours, days, weeks, months or even years. Again, preferably, the person is asked to think about or mood-focus on the same subject each time and select and put together the mood-rings. Any changes in the mood-rings over the period of time may be used as a guide to understanding the change in mood state of the person over that period of time.

The process of forming the mood-ring can be performed on the electronic device with the programme allowing the person to form a mood-ring as already defined by selecting coloured rings of desired dimensions on the display device of the device. The mood-ring so formed can be stored in the storage device for later review and/or comparison with other tests.

In addition to providing a means of graphically representing a mood state, the electronic device can be used to analyse the graphical representations and provide statistical analyses thereof. For example, the computer can allocate a score to each primary mood based on the graphical representation such that the total score adds to 100 or some other number. A so-called FASH (Fear/Anger/Sad/Happy) score, index or ration can then be output by the computer. For example, in focussing on a selected subject, one person might be determined to have a FASH index of 10:20:30:40. Another person may instead have a FASH index of 5:25:40:30 for the same subject. Other results can readily be envisaged.

In yet another embodiment, the FASH score or index can be used to form a still further graphical representation of the selected mood state of the person. In this regard, the graphical representation can comprise two sets of balanced arms, with a first arm supporting the fulcrum of a second arm. The first arm can be representative of the primary moods “fear” and “anger” while the second arm can be representative of the primary moods “happy” and “sad”. The present inventor has coined the term “mood-balance tower” for this graphical representation of overall mood state. The colours and lengths of the left and right sides of two arms are determined by the person's choice of primary mood colours and in proportion to FASH ratio.

Where the determined score for the primary moods “Fear” and “Anger” are the same, the first arm will be graphically depicted as evenly balanced with the length of the left and right side of the arm being equidistant from the fulcrum. Where the score allocated to “fear” is greater than or less than the score allocated to “anger”, the first arm will be depicted as unbalanced, with the degree of unbalance being dependent on the difference between the scores allocated to these two primary moods. If the score allocated to “Fear” is less than that allocated to “Anger”, the first balance arm will be depicted as tipped relatively downwardly on the “Anger” side of the balance in proportion to the difference between the relative scores for “Fear” and “Anger”.

Where the determined score for the primary moods “Happy” and “Sad” are the same, the second arm will be graphically depicted as evenly balanced. Where the score allocated to “Happy” is greater than or less than the score allocated to “Sad”, the second balance arm will be depicted as unbalanced, with the degree of unbalance again being dependent on the difference between the scores allocated to these two primary moods.

The graphical representation of the second arm, which represents “Happy” and “Sad” being supported by the first arm representing “anger” and “fear”, is in accordance with an epigenetic aspect of the QMT postulated by the present inventor. The primary moods “Anger” and “Fear” are core emotional states which are required to be in some degree of stable equilibrium to allow the two remaining, more evolved, primary moods of “Happy” and “Sad” to in turn find some equilibrium. For example, it is far harder for a person to maintain a good balance between the primary moods of “Happy” and “Sad” if the person's core states of “Anger” and “Fear” are significantly unbalanced.

The depiction of two balanced arms provides a further graphical representation of mood state. As with the mood-pie described above, the process can be repeated on one or more occasions over a period of time, with the period of time constituting minutes, hours, days, weeks, months or even years. Preferably, the person is asked to think about or mood-focus on the same subject each time and select the relative proportions of the four primary moods using the tools described herein following which the balancing arms are generated. Any changes in the mood-balance over the period of time may be used as a guide to understanding the change in mood state of the person over that period of time.

Once the person has graphically represented their mood state, they can be asked by their physician, or the electronic device, to enter some of the thoughts they were having as they graphically represented their mood state. The person preferably enters their thoughts for each of the four primary moods. These thoughts can be stored along with the graphical representation made at that time. These thoughts may be useful for the treating physician but will also provide a valuable future reference source to the person, when reviewing their graphical representations, as to what they thinking when they formed a particular graphical representation.

In another embodiment of this aspect, the graphical representation means can comprise paper having one or more circles or other shapes provided thereon which are able to be coloured in to form a mood-pie as defined herein. In another embodiment, the paper can have one or more Cartesian planes or Cartesian spaces provided thereon which can be used to form mood-compasses and/or mood-quadrangles as defined herein.

In this regard, the graphical representation means preferably includes a set of coloured pencils that can be selected by the person, with the colour being representative of a primary mood.

In another embodiment, the graphical representation means can comprise a series of coloured rings. The series preferably includes at least four different coloured sets of rings, which set comprising a relatively small central disc and three other rings, each of increasing dimension. In one embodiment, the rings are preferably annular with the central disc being circular. In another embodiment, the rings can be formed of another shape, such as a square, rectangle, and so on.

In a preferred embodiment, the respective rings of a particular colour are sized such that they are concentrically positionable together. In this regard, the different coloured sets are preferably compatible in dimension so that the person can build up a series of concentric rings and a central disc representative of their mood state as defined herein.

In another embodiment, the four moods can be represented by three differently coloured and sized concentric shells that in turn are positionable around a small coloured central core element akin to the “babushka” dolls of Russia. The person can be presented with a set of various differently coloured shells and central elements of various sizes and can then be allowed, following a mood-focus, to put together the shells and central element in a manner representative of their mood state. For example, the person can be presented with four colour sets of shells and central elements. The person is then allowed to select a central element from one of the four colours, a first shell that is immediately larger than the central element of a second colour, a second shell that is immediately larger than the first shell of a third colour, and finally a third shell that is immediately larger than the second shell of a fourth colour. The third shell is representative of their predominant primary mood about that focus, with the second shell, first shell, and central element being representative in decreasing predominance of the other three primary moods. It will be appreciated that the shells and central element can be of any colour, shape and/or have any decoration or patterning thereon.

The process of forming mood-rings or using the concentric shells can be repeated on one or more occasions over a period of time, with the period of time constituting minutes, hours, days, weeks, months or even years. Again, preferably, the person is asked to think about or mood-focus on the same subject each time and select and put together the mood-rings or shells. Any changes in the mood-rings or shells over the period of time may be used as a guide to understanding the change in mood state of the person over that period of time.

According to a further aspect, the present invention is a computer programme for graphically representing a selected mood state of a person by:

(a) presenting a graphical representation means to the person; and

(b) requesting the person use the graphical representation means to graphically represent the proportion that each of a number of primary moods contributes to the selected mood state.

According to a yet another aspect, the present invention is a computer readable medium containing machine-executable programme code for graphically representing a selected mood state of a person, the code, on execution by a computer, resulting in the computer:

(a) presenting a graphical representation means to the person; and

(b) requesting the person use the graphical representation means to graphically represent the proportion that each of a number of primary moods contributes to the selected mood state.

In these further aspects, the programme and/or computer readable medium can be adapted to perform any one of the steps as defined herein in accordance with the first aspect of the present invention. Still further, the programme and/or computer readable medium can be used in conjunction with the system as defined herein in accordance with the second aspect of the present invention.

By providing graphical representation of mood states, the present invention can be used in the diagnosis, analysis and/or treatment of mood and mood disorders. The present invention provides a person (with appropriate training), or a physician, with a means of determining mood state and allowing monitoring and comparison of mood state over periods of time. The information provided by the present invention can then be used by the person and/or physician as one input in considering techniques for changing mood. In particular, it provides a person and their physician with a means of readily noting that their mood state has deteriorated and taking steps to adjust their mood state before the onset of more serious disorders such as depression. It also provides a means of delivering positive feedback to a person attempting to improve their mood and so provide encouragement to continue the process with a view to improving their mood.

The present invention is further particularly suitable for children and provides a means of introducing concepts of mental health to children in a non-threatening and educational way.

### BRIEF DESCRIPTION OF THE DRAWINGS

By way of example only, a preferred embodiment of the invention is now described with reference to the accompanying drawings, in which:

FIG. 1 is a flow chart of a method according to the present invention for determining the mood state of a person;

FIGS. 2a-2e depict screens from an electronic device running the method according to the present invention in which a person selects colours as representative of the four primary moods;

FIGS. 3a-7b depict various menus that are presented to the person to allow them to select their mood-focus;

FIG. 8 is a view of the display screen of a small handheld computer, such as a personal organiser, that can be used to perform the method;

FIG. 9 is a view of a mood pie formed using the programme;

FIG. 10 is a view of a mood-compass formed on a Cartesian plane using the programme;

FIG. 11 is a mood-quadrangle formed using the programme;

FIG. 12 is a mood compass formed in a Cartesian space using the programme;

FIG. 13 is a three dimensional representation formed in a Cartesian space using the programme;

FIG. 14 is a mood-ring made by using the method according to the present invention; and

FIG. 15 depicts an output from the programme including FASH indices;

FIG. 16 is an example of a further graphical representation of the mood state of the person based on use of the FASH indices;

FIG. 17 is a side view of a set of shells and a central element that are concentrically positionable together for use as a mood tool in the present invention.

### PREFERRED MODE OF CARRYING OUT THE INVENTION

As described herein, the present inventor proposes a theory that four primary moods (i.e. Happy, Sad, Fear and Anger) combine in various combinations to generate a multitude of secondary moods. A person's mood state will typically be a secondary mood state that is based on some combination of these four primary moods. This theory which the inventor has termed the “Quaternary Mood Theory” has the potential to provide an integrated and simple approach to understanding mood. The inventors clinical and research experience combined with the symmetrical, bi-hemispheric neuroanatomical architecture of the human brain supports this Quaternary Mood Theory.

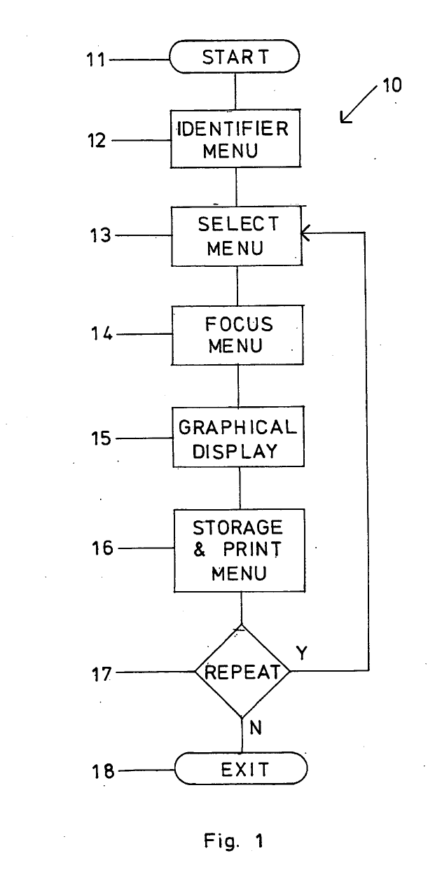

A flow chart depicting the steps of a method of graphically representing the mood state of a person using a system in the form of an electronic device is depicted generally as 10 in FIG. 1. The method can be performed by a computer programme software running on a computer. The program can be stored on computer-readable medium, such as a hard disc, floppy disc or other appropriate storage device.

The method 10 comprises a first Start step 11 where the person loads the software into the electronic device. The device then displays an Identifier Menu 12 where the person can enter their details, such as their name, age, and/or identifier number.

Once in the programme, the device displays a Select Menu 13. From this menu, the person can select a colour for each of a number of primary moods. In the method 10, the person will normally be presented with a range of colours to which can be assigned a primary mood. These colours include black, red, green, yellow, dark blue, brown, light blue, purple and white. Other colours can be envisaged.

When presented with the Select Menu 13, the person is asked to assign a colour to four primary moods. In the case of children, the primary moods will typically be represented by the words “Happy”, “Sad”, “Fear” and “Anger”. In the case of adults, the four primary moods may be presented in less confronting language as “Delight”, “Reflection”, “Caution” and “Assertion”.

It is generally regarded that there is no correct colour to identify these primary moods. The method 10 does though allow the person to select which colour is representative of which primary mood. Changes in the selection of colour for a particular primary mood may be noted by the physician and used to monitor changes in mood state.

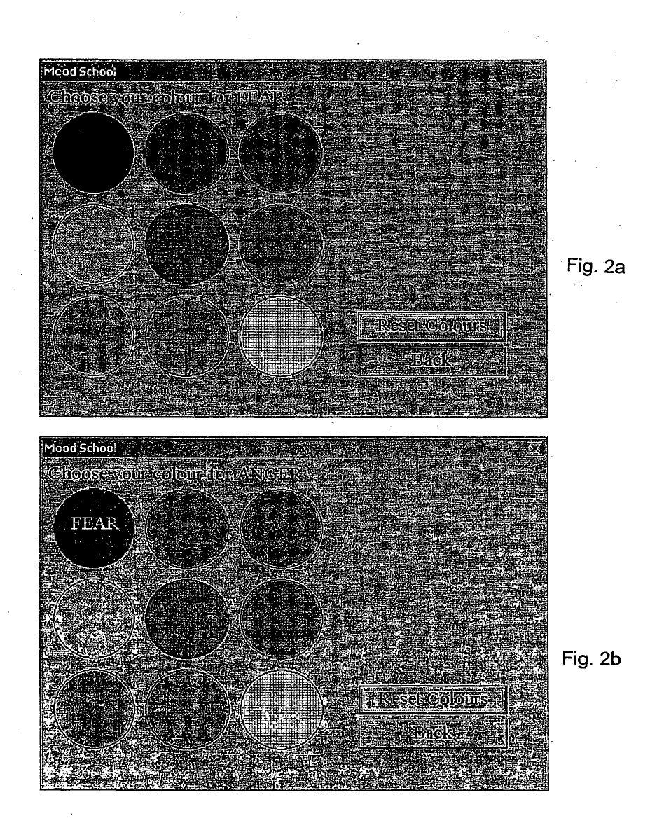

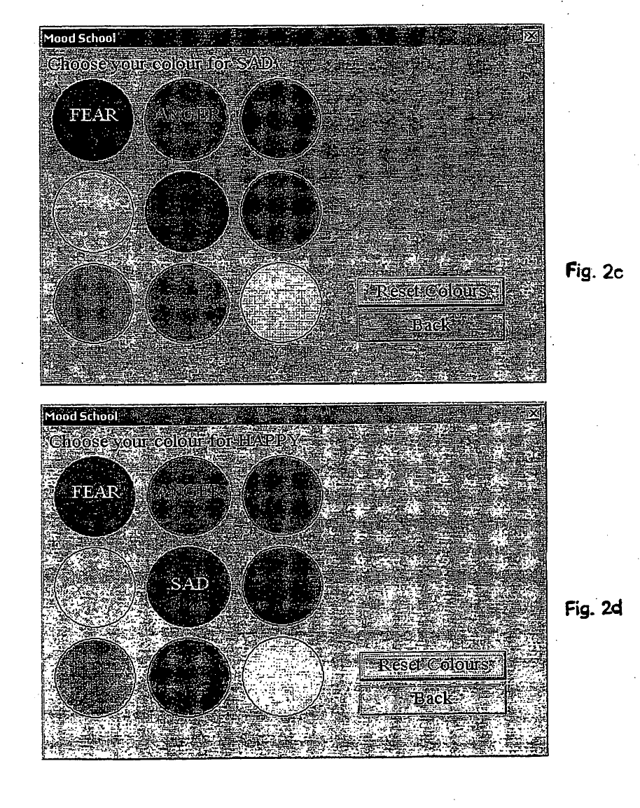

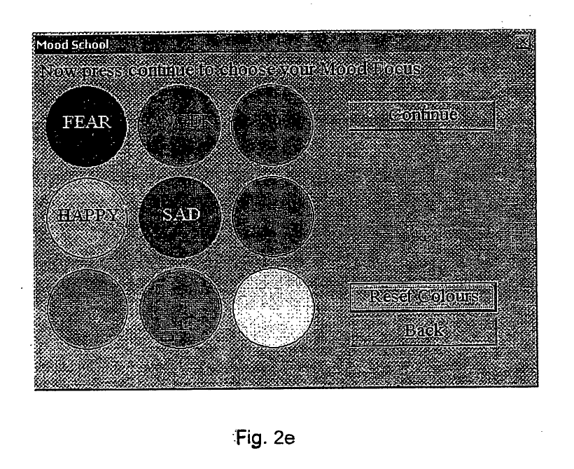

FIGS. 2a-2e depict the various steps of selecting different colours for each of the primary moods. In FIG. 2a, the person is asked to “Choose your colour for FEAR”. As depicted by FIG. 2b, the person has chosen Black as representative of this primary mood. Also in FIG. 2b, the person is asked to “Choose your colour for ANGER”. As depicted by FIG. 2c, the person has chosen Red as representative of this primary mood. Also in FIG. 2c, the person is asked to “Choose your colour for SAD”. As depicted by FIG. 2d, the person has chosen Dark Blue as representative of this primary mood. Also in FIG. 2d, the person is asked to “Choose your colour for HAPPY”. As depicted by FIG. 2e, the person has chosen Yellow as representative of this primary mood. Also in FIG. 2e, the person is asked to “Now press continue to choose your Mood Focus”.

Once the person has chosen their four colours, the person enters a Focus Menu 14. This step requires the person to think about or mood-focus on a particular subject. In this regard, the person may choose to think about or focus on a particular subject or may be prompted to do so by their physician. In the case of an adult, the subject may be something familiar to that person such as their workplace, or their human relationships. In respect of children, the subject may be school, a sport, family members, or a particular friend.

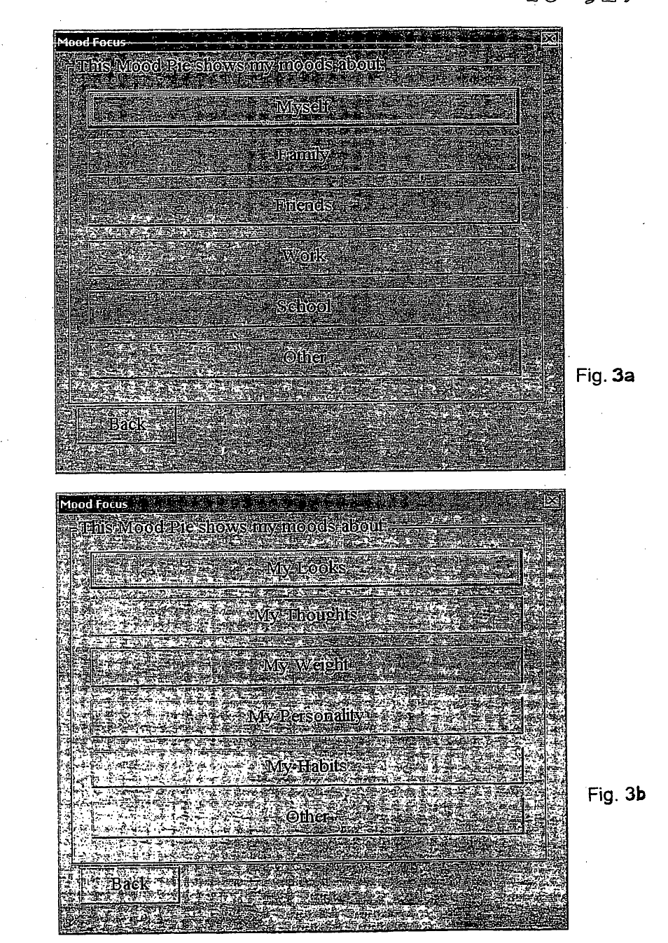

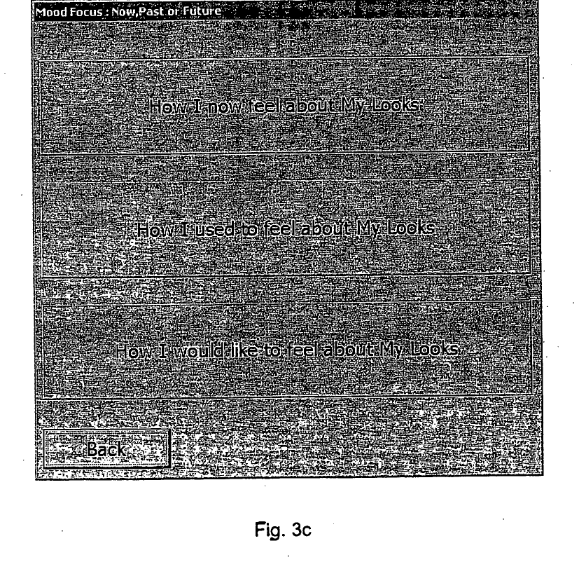

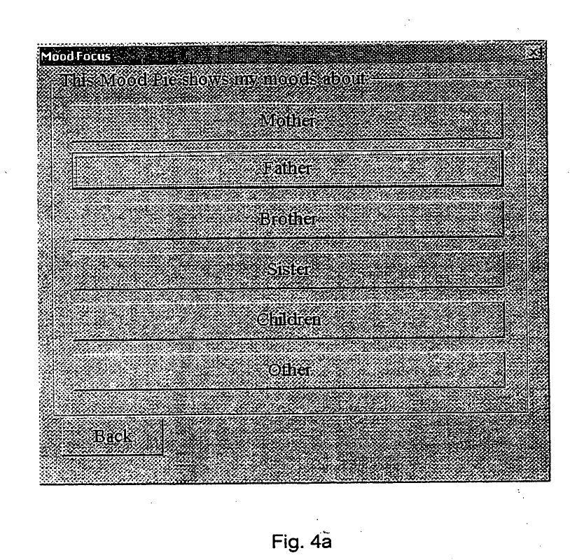

As depicted by FIGS. 3a to 7b, the device can display various options for the person to select as their mood-focus. As depicted in FIG. 3a, the subjects presented to the person might include:

Myself

Family

Friends

Work

School

Other.

Where the person chooses “Myself”, the person can be presented with a sub-menu of subjects as depicted in FIG. 3b, namely:

My Looks

My Thoughts

My Weight

My Personality

My Habits

Other

Where the person chooses one of these subjects, the person can be presented with a still further sub-menu of subjects as depicted by FIG. 3c. Where the person has selected “My Looks”, for example, the person is presented with the following list of foci:

How I now feel about my looks.

How I used to feel about my looks.

How I would like to feel about my looks.

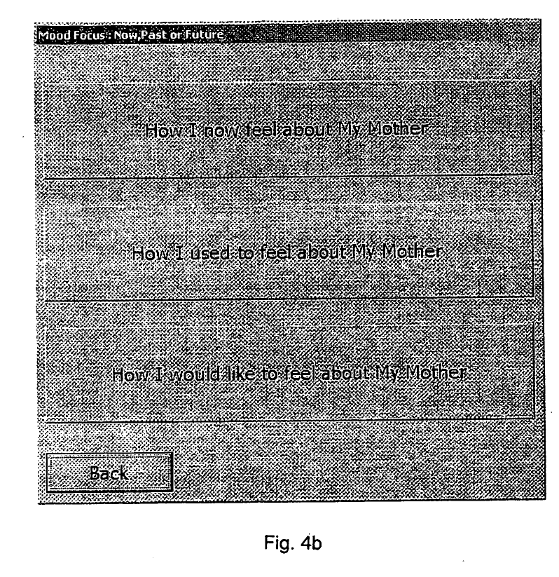

Similar statements are presented to the person should they choose one of the other subjects in the sub-menu depicted in FIG. 3b. Where the person chooses “Other”, the programme would preferably allow the person to enter the subject that is person is proposing to focus on.

Where the person chooses the subject “Family”, the person can be presented with a sub-menu of subjects as depicted in FIG. 4a, namely:

Mother

Father

Brother

Sister

Children

Other

Where the person chooses one of these subjects, the person can be presented with a still further sub-menu of subjects as depicted in FIG. 4b. Where the person has selected “Mother”, for example, the person is presented with the following list of foci:

How I now feel about my mother.

How I used to feel about my mother.

How I would like to feel about my mother.

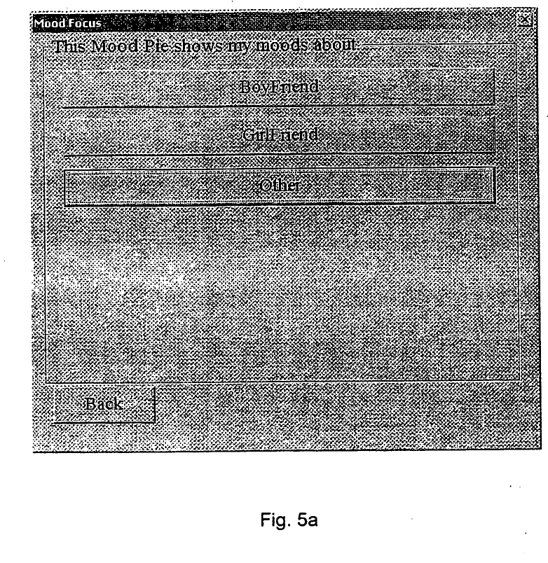

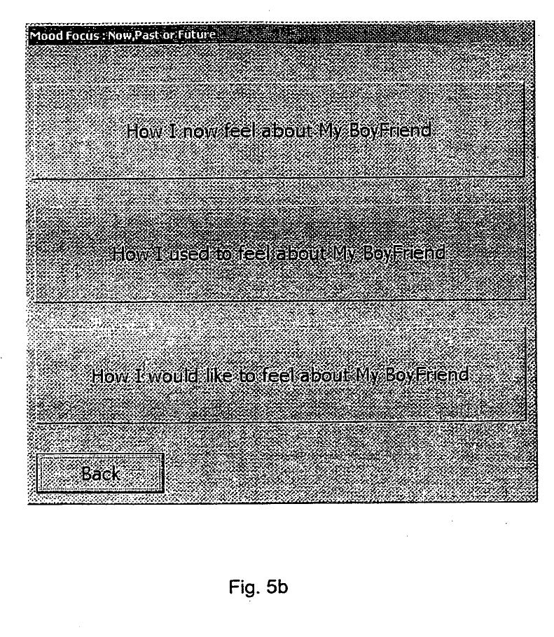

Similar statements might be presented for each of the subjects in the sub-menu of FIG. 4a.

Where the person chooses “Friends”, the person can be presented with a sub-menu of subjects as depicted in FIG. 5a, namely:

Boyfriend

Girlfriend

Other

Where the person chooses one of these subjects, the person can be presented with a still further sub-menu of subjects as depicted in FIG. 5b. Where the person has selected “Boyfriend”, for example, the person is presented with the following list of foci:

How I now feel about my boyfriend.

How I used to feel about my boyfriend.

How I would like to feel about my boyfriend.

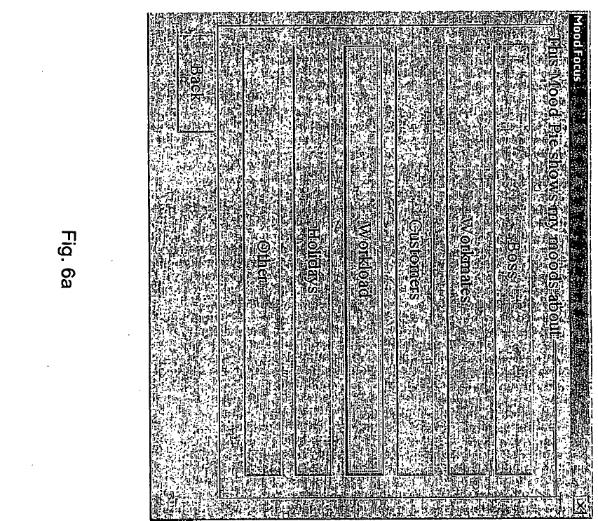

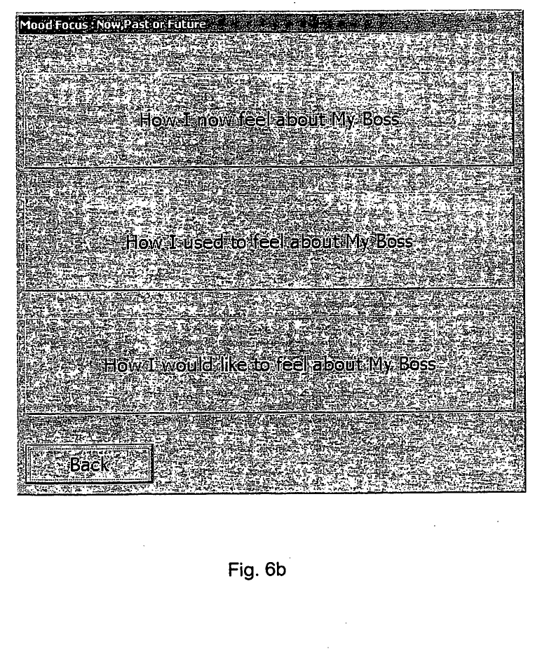

Similar statements might be presented for each of the subjects in the sub-menu.

Where the person chooses “Work”, the person can be presented with a sub-menu of subjects as depicted in FIG. 6a, namely:

Boss

Workmates

Customers

Workload

Holidays

Other

Other subjects, such as “Sick leave” can be envisaged. Where the person chooses one of these subjects, the person can be presented with a still further sub-menu of subjects as depicted in FIG. 6b. Where the person selects “Boss”, for example, the person is presented with the following list of foci:

How I now feel about my boss.

How I used to feel about my boss.

How I would like to feel about my boss.

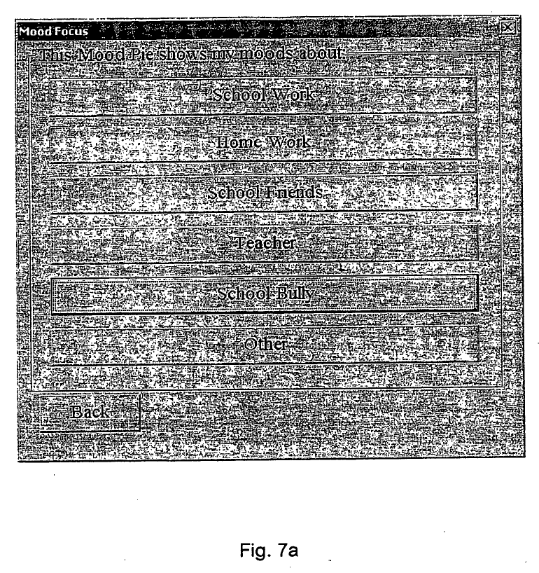

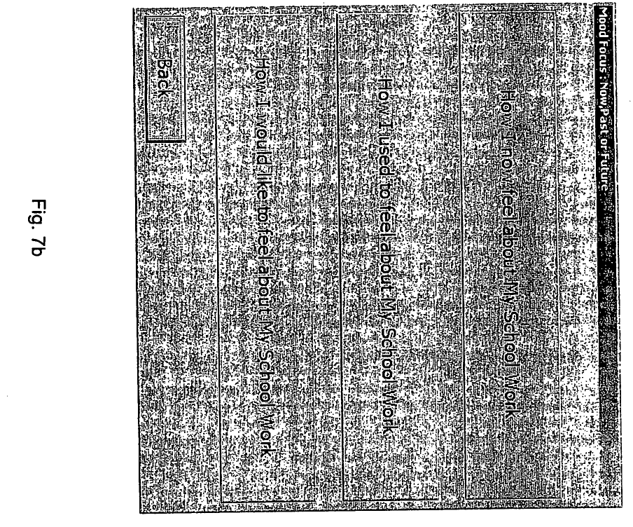

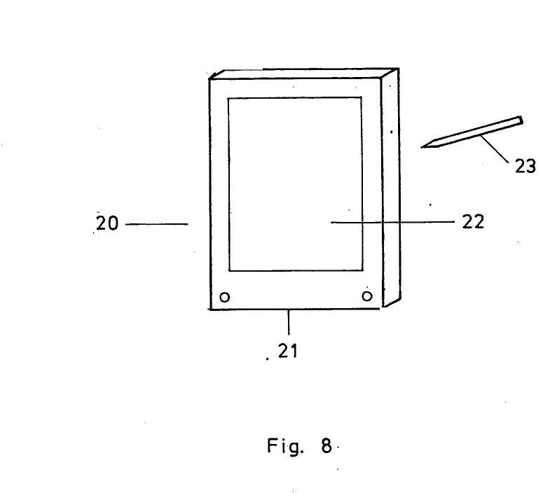

Similar statements might be presented for each of the subjects in the sub-menu.

Where the person chooses “School”, the person can be presented with a sub-menu of subjects as depicted in FIG. 7a, namely:

School work

Homework

School friends

Teacher

School bully

Other

Other subjects such as “Examinations” and “Sick days” can be envisaged. Where the person chooses one of these subjects, the person can be presented with a still further sub-menu of subjects as depicted in FIG. 7b. Where the person selects “School work”, for example, the person might be presented with the following list of foci:

How I now feel about my school work.

How I used to feel about my school work.

How I would like to feel about my school work.

Similar statements might be presented for each of the subjects in the sub-menu.

Once the mood-focus has been identified, the method comprises a step 15 in which the person is presented with a graphical display screen.

A number of techniques or “mood tools” can be used to perform step 15 in which the person graphically represents the contribution each primary mood makes to the mood state resulting from the person's mood-focus.

In one arrangement, the electronic device can be a handheld computer 20 as depicted in FIG. 2.

While the depicted device 20 is a handheld computer, the method 10 could be performed on a desktop computer, a laptop computer, a notebook type computer, a personal organiser, or a cellular telephone. In another embodiment, a system comprising paper and pencils could be utilised and will be described as appropriate below.

The depicted device 20 has a microprocessor housed in a case 21, a visual display touch screen 22, and a touch stylus 23. In a further embodiment, the computer preferably has a data storage device. The device 20 uses software instructions to run a programme that allows a person to graphically represent their mood state.

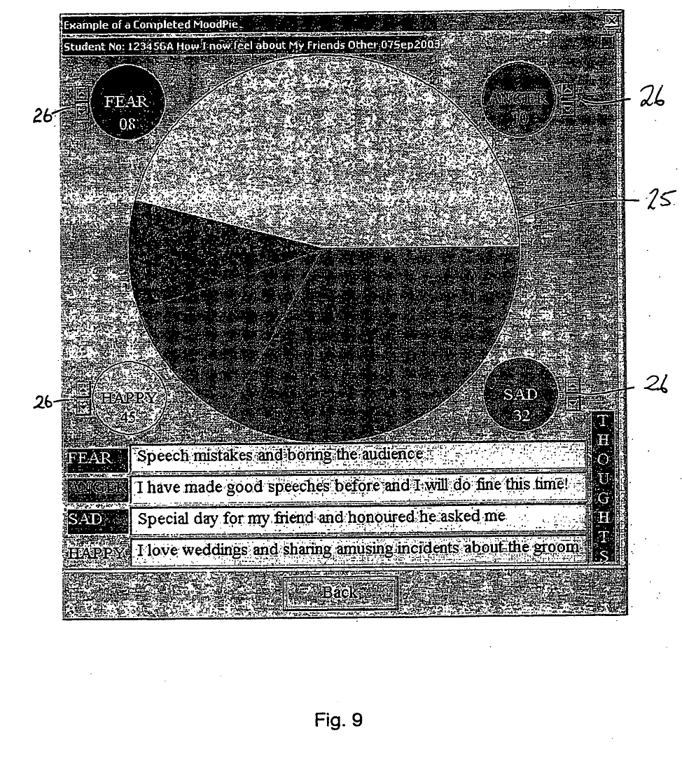

As depicted in FIG. 9, the screen 22 can display a circle 25 that is able to be coloured in by the person. Other shapes that can be coloured in can be envisaged. In this regard, the person presses each of the up and down buttons to increase or decrease the degree to which the circle 25 is coloured in by the colours selected by the person as representative of the four primary moods.

In the example depicted in FIG. 9, the person is an adult and has chosen to focus on an upcoming speech they have been requested to give at a friend's wedding. The biggest slice of the pie chart or mood-pie is Happy. The person has also entered a comment that they “love weddings and sharing amusing incidents about the groom”. The person though has also allocated space in the mood-pie to Fear, Anger and Sad but in smaller proportions. This mod-pie reflects a relatively balanced mood state to the upcoming speech. A mood-pie in which the slices allocated to Fear or Anger were quite large would reflect an unbalanced mood state in respect of the upcoming speech.

In another example, a child that has been asked to focus on their feelings about school and who enjoys school may choose to fill a significant portion of the pre-defined area with a colour that has been selected by that child as representative of the primary mood “Happy”, with much less of the area coloured in the colour selected for the primary mood state of “Sad”, “Fear” or “Anger”. For a child that does not enjoy school or is experiencing bullying at school, the reverse may be expected. This process is repeated for each of the primary moods until the pre-defined area is full.

As depicted in FIG. 1, the person is presented at step 16 with an option of storing and/or printing the mood-pie for later review and/or comparison with other tests. At step 17, the person can choose to repeat the process or exit the program (step 18).

The method 10 can be repeated on one or more occasions over a period of time. The period of time might constitute minutes, hours, days, weeks, months or even years. Preferably, the person is asked to think about or mood-focus on the same subject each time and colour in a mood-pie representative of the primary moods. Any changes in the mood-pie over the period of time may be used as a guide to understanding the change in mood state of the person over that period of time.

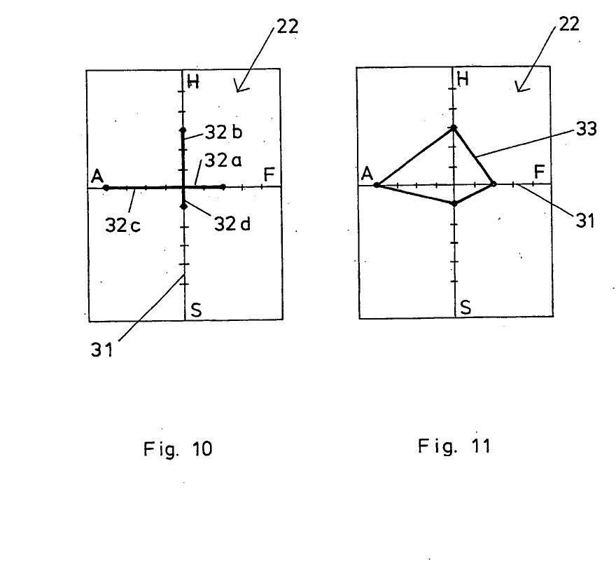

As depicted in FIGS. 10 and 11, the screen 22 can instead display a Cartesian plane 31 (or xy-plane) that allows the person to plot a mood-compass and/or mood-quadrangle as defined herein.

In FIG. 10, the person is asked to assign a number between 0 and 10 that is representative of the contribution a primary mood makes to their selected mood state. This may be repeated for each of the four primary moods defined herein.

The numbers chosen by the person are plotted on the axes of the Cartesian plane 31. In the depicted embodiment, the positive side of the y-axis is representative of “Happy” (or “Delight”) while the negative side of the y-axis is representative of “Sad” (or “Reflection”). The positive side of the x-axis is representative of the primary mood “Fear” (or “Caution”) while the negative side of the x-axis is representative of “Anger” (or “Assertion”).

The use of the axes of the Cartesian plane in other combinations can be envisaged. For example, the primary moods “Happy” and “Sad” can instead be plotted on the x-axis while the primary moods “Fear” and “Anger” can be plotted on the y-axis.

In the embodiment, the person in focussing on a particular subject can select a number between 0 and 10 for each primary mood and then plot this number on the axes of the Cartesian plane 31. In the depicted embodiment, a coloured line (32a, 32b, 32c, 32d) is drawn from the origin of the Cartesian plane 31 to each of the plots. The colour of each of these lines can be selected in the manner depicted in FIG. 2a-2e. The result is four coloured lines (32a-32d) of individual length extending from the origin of the Cartesian plane 31. This set of four lines or “mood-compass” presents in graphical form the mood state of the person. As with the mood-pie described above, the process can be repeated on one or more occasions over a period of time, with the period of time constituting minutes, hours, days, weeks, months or even years. Preferably, the person is asked to think about or mood-focus on the same subject each time and plot their primary moods and form a mood-compass. Any changes in the mood-compass over the period of time may be used as a guide to understanding the change in mood state of the person over that period of time.

It will be appreciated that in forming the mood-compass, the number does not need to be between 0 and 10 and can instead be between any two numbers. In another embodiment, for example, the person may select a number between 0 and 100.

As depicted in FIG. 11, a quadrangle 33 can then be formed by joining the plots made on the Cartesian plane 31. This four-sided figure or “mood-quadrangle” 33 also presents in graphical form the mood state of the person. As with the mood-pie described above, the process can be repeated on one or more occasions over a period of time, with the period of time constituting minutes, hours, days, weeks, months or even years. Again, preferably, the person is asked to think about or mood-focus on the same subject each time and plot their primary moods and form a mood-quadrangle 33. Any changes in the mood-quadrangle 33 (eg. shape and/or area) over the period of time may be used as a guide to understanding the change in mood state of the person over that period of time.

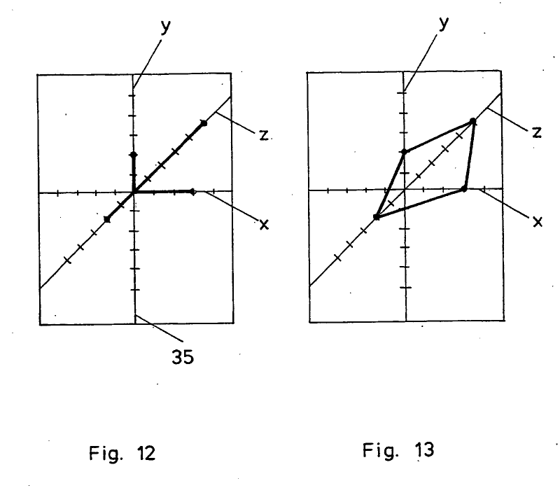

As depicted in FIGS. 12 and 13, the graphical representation can be plotted on a Cartesian space (or xyz-space) 35 instead of just a Cartesian plane. In this regard, one or two of the primary moods may be plotted on a z axis of the Cartesian space 35. This has the potential of allowing the person to form three-dimensional representations of their mood state. As depicted in FIG. 12, this can be a three-dimensional mood-compass or as depicted in FIG. 13 a three-dimensional mood shape.

As with the mood-pie described above, the process depicted in FIGS. 12 and 13 can be repeated on one or more occasions over a period of time, with the period of time constituting minutes, hours, days, weeks, months or even years. Preferably, the person is asked to think about or mood-focus on the same subject each time and plot their primary moods on the Cartesian space 35. Any changes in the shape of the three-dimensional representation over the period of time may be used as a guide to understanding the change in mood state of the person over that period of time.

The programme running on device 20 can automatically generate a mood-quadrangle 33 on completion of the mood-compass by the person. The mood-compass or mood-quadrangle 33 can be stored in the storage device for later review and/or comparison with other tests.

In yet another embodiment, the programme can allow the person to form a mood-ring 41 as depicted in FIG. 14 by selecting coloured rings of desired dimensions on the screen 22 of the device 20. The mood-ring so formed can be stored in the storage device for later review and/or comparison with other tests.

To form the mood-ring 41, the person using the device 20 can be presented on the screen 22 with a set of coloured rings of varying diameters. In using these rings, the person can select a ring colour representative of a particular primary mood and then select from a range of sizes a ring of a particular diameter representative of the degree to which a primary mood is representative of their feelings about the selected subject or focus. Generally, the greater the proportion a primary mood is representative of their feelings about said subject, the larger the ring diameter.

As depicted, the person will preferably be instructed to put together the set of concentric rings by starting with what they regard as their predominant primary mood about the subject or focus and then work inwardly placing smaller diameter rings representative of the other primary moods within the firstly selected largest ring to form a graphical representation of their mood state.

In the embodiment depicted in FIG. 14, the mood-ring 41 has been put together from three annular rings and a central disc. The outer ring 42 is representative of a first primary mood (eg. happy); the ring 43 immediately inward of the outer ring 42 is of a different colour and is representative of a different primary mood (eg. angry). The next inner ring 44 is of a still different colour and is representative of yet a different primary mood (eg. fearful) while the inner disc 45 is of a still different colour and representative of the final primary mood (eg. sad).

As with the mood-pie described above, the process of forming a mood-ring can be repeated on one or more occasions over a period of time, with the period of time constituting minutes, hours, days, weeks, months or even years. Again, preferably, the person is asked to think about or mood-focus on the same subject each time and select and put together the mood-rings. Any changes in the mood-rings over the period of time may be used as a guide to understanding the change in mood state of the person over that period of time.

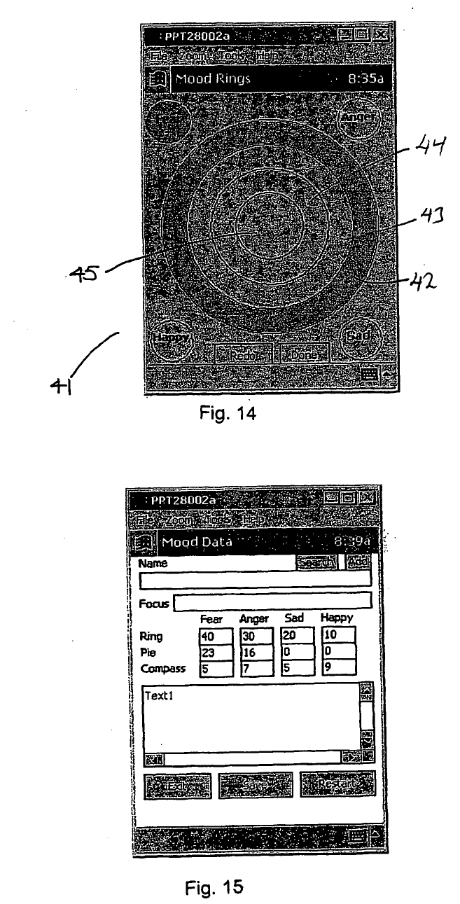

In addition to providing a means of graphically representing a mood state, the device 20 can be used to analyse the graphical representations and provide statistical analyses thereof. For example, the device 20 can allocate a score to each primary mood based on the graphical representation such that the total score adds to 10, or 100, or some other number. A so-called FASH (Fear/Anger/Sad/Happy) score or index can then be output by the device 20 as depicted in FIG. 15. The scores from different methods of graphically representing the mood-state can also be compared.

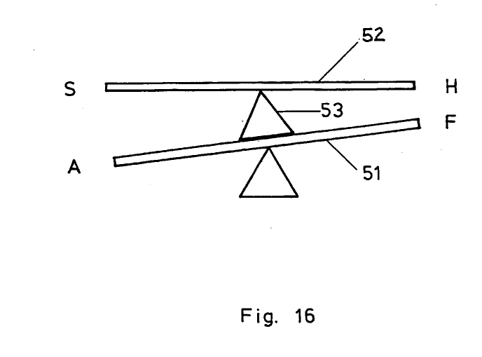

As depicted in FIG. 16, the FASH score or index can be used to form a still further graphical representation of the selected mood state of the person. In this regard, the graphical representation can comprise two sets of balanced arms 51,52, with a first arm 51 supporting the fulcrum 53 of a second arm 52. The first arm can be representative of the primary moods “fear” and “anger” while the second arm can be representative of the primary moods “happy” and “sad”. The present inventor has coined the tern “mood-balance tower” for this graphical representation of overall mood state.

Where the determined score for the primary moods “Fear” and “Anger” are the same, the first arm will be graphically depicted as evenly balanced with the length of the left and right side of the arm being equidistant from the fulcrum. Where the score allocated to “fear” is greater than or less than the score allocated to “anger”, the first arm will be depicted as unbalanced, with the degree of unbalance being dependent on the difference between the scores allocated to these two primary moods, as is depicted in FIG. 16. If the score allocated to “Fear” is less than that allocated to “Anger”, the first balance arm will be depicted as tipped relatively downwardly on the “Anger” side of the balance in proportion to the difference between the relative scores for “Fear” and “Anger”.

Where the determined score for the primary moods “Happy” and “Sad” are the same, the second arm will be graphically depicted as evenly balanced as is depicted in FIG. 16. Where the score allocated to “Happy” is greater than or less than the score allocated to “Sad”, the second arm will be depicted as unbalanced, with the degree of unbalance again being dependent on the difference between the scores allocated to these two primary moods.

The graphical representation of the second arm, which represents “Happy” and “Sad” being supported by the first arm representing “anger” and “fear” is in accordance with an epigenetic aspect of the QMT postulated by the present inventor that the primary moods “Anger” and “Fear” are core emotional states which are required to be in some degree of stable equilibrium to allow the two remaining, more involved, primary moods of “Happy” and “Sad” to in turn find some equilibrium. For example, it is far harder for a person to maintain a good balance between the primary moods of “Happy” and “Sad” if the person's core states of “Anger” and “Fear” are significantly unbalanced.

The depiction of two balanced arms provides a further graphical representation of mood state. As with the mood-pie described above, the process can be repeated on one or more occasions over a period of time, with the period of time constituting minutes, hours, days, weeks, months or even years. Preferably, the person is asked to think about or mood-focus on the same subject each time and select the relative proportions of the four primary moods using the tools described herein following which the balancing arms are generated. Any changes in the mood-balance over the period of time may be used as a guide to understanding the change in mood state of the person over that period of time.

While a computer based system for performing the method 10 as described above is envisaged as being preferred, it will be appreciated that the method 10 could be performed in other ways.

For example, in one embodiment, the graphical representation device could comprise paper having one or more circles or other shapes provided thereon which are able to be coloured in to form a mood-pie as defined herein. In another embodiment, the paper can have one or more Cartesian planes or Cartesian spaces provided thereon which can be used to form mood-compasses and/or mood-quadrangles as defined herein.

In this regard, the system preferably includes a set of coloured pencils that can be selected by the person, with the colour being representative of a primary mood.

In another embodiment, the graphical representation device can comprise a physical kit comprising a series of coloured rings. In a manner similar to what is displayed electronically in FIG. 14, the kit can include at least four different coloured sets of rings, which set comprising a relatively small central disc 45 and three other rings (42-44), each of increasing dimension.

In a preferred embodiment of the kit, the respective rings of a particular colour are sized such that they are concentrically positionable together. In this regard, the different coloured sets are preferably compatible in dimension so that the person can build up a series of concentric rings and a central disc representative of their mood state as defined herein.

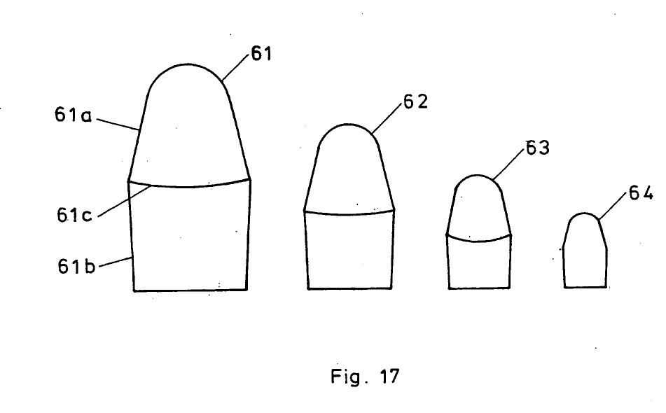

In another embodiment, and as is depicted in FIG. 17, the four moods can be represented by three differently coloured and sized concentric shells (61,62,63) that in turn are positionable around a small coloured central core element (64) akin to the “babushka” dolls of Russia. It will be seen that each of the shells (61,62,63) can be pulled apart into two parts. For example, shell 61 has a top part 61a and a bottom part 61b that can be frictionally engaged with each other around join line 61c. This construction allows shell 63 to be opened and element 64 to be placed therein. Once element 64 is placed therein and shell 63 is re-formed, it can in turn be placed inside shell 62, which once formed can in turn be placed inside shell 61.

The person can be presented with a set of various differently coloured shells and central elements of various sizes and can then be allowed, following a mood-focus, to put together the shells and central element in a manner representative of their mood state. For example, the person can be presented with or select four different coloured versions of the set of shells and central elements depicted generally as 60 in FIG. 17. For example, the person might be presented with four sets of the colours black, green, red and blue. Other colours can be envisaged.

The person is then allowed to select a central element 64 from one of the four colours, a first shell 63 that is immediately larger than the central element 64 of a second colour, a second shell 62 that is immediately larger than the first shell 63 of a third colour, and finally a third shell 61 that is immediately larger than the second shell 62 of a fourth colour. The third shell 61 is representative of their predominant primary mood about that focus, with the second shell 62, first shell 63, and central element 64 being representative in decreasing predominance of the other three primary moods. It will be appreciated that the shells and central element can be of any colour, shape and/or have any decoration or patterning thereon.

In the set depicted in FIG. 17, the person might, for example, having undertaken a mood-focus, have chosen the third shell 61 to be representative of the primary mood “happy”, the second shell 62 to be representative of the primary mood “sad”, the first shell 63 to be representative of the primary mood “anger” and the central element 64 to be representative of the primary mood “fear”. The person might be encouraged to concentrically position the shells and central element and then pull it apart while explaining to their consulting physician why they put together the shells in the particular order that they chose. This tool again uses colour and shape to allow the person to represent a mood state in a non-verbal way.

The process of forming mood-rings or using the concentric shells can be repeated on one or more occasions over a period of time, with the period of time constituting minutes, hours, days, weeks, months or even years. Again, preferably, the person is asked to think about or mood-focus on the same subject each time and select and put together the mood-rings or shells. Any changes in the mood-rings or shells over the period of time may be used as a guide to understanding the change in mood state of the person over that period of time.

The present invention provides a person (with appropriate training) or a physician with a means of determining mood state and allowing monitoring and comparison of mood state over periods of time. The information provided by the present invention can then be used by the person and/or physician as one input in considering techniques for changing mood. In particular, it provides a person and their physician with a means of readily noting that their mood state has deteriorated and taking steps to adjust that before the onset of more serious disorders such as depression or bipolar disorder. It also provides a means of delivering positive feedback to a person attempting to improve their mood and so provide encouragement to continue the process. The coloured visuo-spatial manner in which these inventions express mood are proposed by the inventor to be registrable, both passively and actively, with the deeper and phylogenetically older non-verbal areas of the brain associated with mood formation.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method of graphically representing a selected mood state of a person, the method comprising the steps of:
(a) presenting a graphical representation means to the person; and
(b) having the person use the graphical representation means to graphically represent the proportion that each of a number of primary moods contributes to the selected mood state.

2. The method of claim 1 of graphically representing a selected mood state of a person further comprising a step of:
(c) displaying the result of the graphical representation.

3. The method of graphically representing a selected mood state of a person of claim 2 wherein the person can use colour and/or dimension to graphically represent the proportion that said each of a number of primary moods contributes to said selected mood state.

4. The method of graphically representing a selected mood state of a person of claim 3 wherein the steps are performed in combination with input received from a physician.

5. The method of graphically representing a selected mood state of a person of claim 3 wherein the person is required to input identification details prior to step (b).

6. The method of graphically representing a selected mood state of a person of claim 5 wherein the identification details include the person's name, address, age, and/or identifier number.

7. The method of graphically representing a selected mood state of a person of claim 3 further comprising a step where the person selects which of a plurality of colours is representative to them of a particular primary mood.

8. The method of graphically representing a selected mood state of a person of claim 7 wherein the person is asked to assign a colour to four primary moods.

9. The method of graphically representing a selected mood state of a person of claim 8 wherein the four primary moods are “Fear”, “Anger”, “Sad” and “Happy”.

10. The method of graphically representing a selected mood state of a person of claim 9 further comprising prior to step (b), a step where the person thinks about or focuses on a selected mood state.

11. The method of graphically representing a selected mood state of a person of claim 10 wherein the subject is selected from the group comprising their workplace, their human relationships, a memory, a hope for the future, school, sport, family members, a bully, or a particular friend.

12. The method of graphically representing a selected mood state of a person of claim 11 wherein step (b) comprises colouring in a shape of pre-defined area with the four selected colours, with the proportion of the colours being representative of the proportion of how much that primary mood contributes to the selected mood state.

13. The method of graphically representing a selected mood state of a person of claim 12 wherein the predefined area is in the shape of a circle and the resulting graphical representation is a pie chart.

14. The method of graphically representing a selected mood state of a person of claim 11 wherein step (b) comprises plotting values on a Cartesian plane, with each axis of the plane being representative of one of the four primary moods.

15. The method of graphically representing a selected mood state of a person of claim 14 further comprising the person selecting a number on a scale that is representative of the degree to which each of the primary moods contributes to the selected mood state and plotting these numbers on the respective appropriate axes of the Cartesian plane.

16. The method of graphically representing a selected mood state of a person of claim 15 wherein the positive side of the y-axis is representative of the primary mood “Happy”, the negative side of the y-axis is representative of the primary mood “Sad”, the positive side of the x-axis is representative of the primary mood “Fear” and the negative side of the x-axis is representative of the primary mood “Anger”.

17. The method of graphically representing a selected mood state of a person of claim 15 wherein a coloured line is drawn from the origin of the Cartesian plane to each of the plots made on the Cartesian plane.

18. The method of graphically representing a selected mood state of a person of claim 15 wherein the plots made on the Cartesian plane are used to form a quadrangle that is formed by joining the plots made on the Cartesian plane.

19. The method of graphically representing a selected mood state of a person of claim 11 further comprising the person selecting a number on a scale that is representative of the degree to which each of the primary moods contributes to the selected mood state and plotting these numbers on at least some of the axes of the Cartesian space.

20. The method of graphically representing a selected mood state of a person of claim 19 wherein one or two of the primary moods are plotted on a z axis of the Cartesian space.

21. The method of graphically representing a selected mood state of a person of claim 20 wherein the plots made on the Cartesian space are joined by lines to form a three-dimensional representation of the mood state.

22. The method of graphically representing a selected mood state of claim 12, wherein the process is repeated on one or more occasions over a period of time, with the various graphical representations being stored for later retrieval and/or comparison.

23. The method of graphically representing a selected mood state of a person of claim 11 wherein step (a) comprises presenting the person with a set of coloured rings of varying diameters and step (b) comprises the person selecting a ring colour representative of a particular primary mood and then selecting from a range of sizes of rings of that selected colour a ring of a particular diameter representative of the proportion that that primary mood contributes to the selected mood state.

24. The method of graphically representing a selected mood state of a person of claim 23 wherein the person uses a set of concentric rings and puts them together by starting with what they regard as their predominant primary mood about said subject and then by working inwardly places smaller diameter rings representative of the other primary moods within the firstly selected largest ring to form a graphical representation of their mood state.

25. The method of graphically representing a selected mood state of a person of claim 11 wherein a percentage score is allocated to each primary mood based on the graphical representation such that the total score adds to 100.

26. The method of graphically representing a selected mood state of a person of claim 25 wherein a FASH (Fear/Anger/Sad/Happy) index is prepared based on said scores.

27. The method of graphically representing a selected mood state of a person of claim 25 wherein said scores are used to form a further graphical representation comprising two sets of balanced arms, with variable length and/or colour, with a first arm supporting the fulcrum of a second arm, the first arm being representative of the primary moods “fear” and ”anger” and the second arm being representative of the primary moods “happy” and “sad”.

28. The method of graphically representing a selected mood state of a person of claim 27 wherein where the determined score for the primary moods “fear” and “anger” are the same, the first arm will be graphically depicted as evenly balanced and where the determined score for the primary moods “happy” and “sad” are the same, the second arm will be graphically depicted as evenly balanced.

29. A system for graphically representing a selected mood-state of a person, the system comprising:
a graphical representation means for graphically representing the proportion that each of a number of primary moods contributes to the selected mood state.

30. The system of claim 29 wherein the graphical representation means allows a person to use colour and/or dimension to graphically represent the proportion that said each of a number of primary moods contributes to said selected mood state.

31. The system of claim 30 wherein the system is an electronic device selected from the group comprising a desktop computer, a laptop computer, a notebook type computer, a personal organiser, a handheld game device, and a cellular telephone.

32. The system of claim 31 wherein the electronic device has a microprocessor, a visual display device, an input device, and a data storage device.

33. The system of claim 32 wherein the electronic device uses programme code to run a programme on the device that allows a person to graphically represent the said selected mood state.

34. The system of claim 33 wherein the programme code, on execution, results in the electronic device requiring the person to input identification details before proceeding.

35. The system of claim 33 wherein the programme code, on execution, results in the device displaying a Select Menu which requires the person to select which of a plurality of colours is representative to them of a particular primary mood.

36. The system of claim 35 wherein the Select Menu comprises the display of a plurality of blocks of different colour on the visual display device, from which the person selects colours that are considered representative of each of the primary moods.

37. The system of claim 36 wherein the Select Menu requires the person to assign a colour to four primary moods.

38. The system of claim 37 wherein the four primary moods are “Fear”, “Anger”, “Sad” and “Happy”.

39. The system of claim 33 wherein the programme code, on execution, results in the electronic device asking the person to think about or focus on the selected mood state before they graphically represent said selected mood state.

40. The system of claim 39 wherein details of said selected mood state are enterable into the electronic device using the input device and stored in the data storage device for later retrieval or comparison with other tests.

41. The system of claim 40 wherein the input device is selected from the group comprising a keyboard, a keypad, a mouse, a joystick, a stylus, and a touch screen.

42. The system of claim 38 wherein the visual display device displays a graphical input screen that allows the person to graphically represent the proportion that each primary mood contributes to the selected mood state.

43. The system of claim 42 wherein the graphical input screen comprises a shape of pre-defined area that is able to be coloured in with the selected colours.

44. The system of claim 43 wherein the person selects a first primary mood and then the person is asked to colour in a portion of that area that is representative of how much that primary mood contributes to the selected mood state, the process being repeated for each of the four primary moods.

45. The system of claim 44 wherein the predefined area is a circle, with the coloured in circle being a pie chart.

46. The system of claim 45 wherein the process of forming pie charts is repeated on one or more occasions over a period of time, with the various pie charts being stored in the storage device for later retrieval and/or comparison with other tests.

47. The system of claim 42 wherein the graphical input screen comprises a Cartesian plane.

48. The system of claim 47 wherein the person uses the input device to plot points for each of the primary moods on the four axes of the Cartesian plane.

49. The system of claim 48 wherein the positive side of the y-axis is representative of the primary mood “Happy”, the negative side of the y-axis is representative of the primary mood “Sad”, the positive side of the x-axis is representative of the primary mood “Fear”, and the negative side of the x-axis is representative of the primary mood “Anger”.

50. The system of claim 48 wherein the electronic device draws a coloured line from the origin of the Cartesian plane to each of the plots, with the colours being as selected by the person as representative of that plotted primary mood.

51. The system of claim 48 wherein the electronic device draws a coloured line between each of the plots on the Cartesian plane to form a quadrangle.

52. The system of claim 42 wherein the graphical input screen comprises a Cartesian space, with one or two of the primary moods being plotted on a z axis of the Cartesian space.

53. The system of claim 42 wherein the graphical input screen comprises the depiction of a plurality of coloured rings of different dimensions on the display device of the device, the rings being selectable with the input device so that the person puts together a set of concentric rings by starting with what they regard as their predominant primary mood about said subject and then work inwardly placing smaller diameter rings representative of the other primary moods within the firstly selected largest ring to form a graphical representation of their mood state.

54. The system of claim 42 wherein the electronic device analyses the graphical representations and develops statistical analyses thereof.

55. The system of claim 54 wherein the electronic device allocates a percentage score to each primary mood based on the graphical representation such that the total score adds to 100, the device then generates a FASH (Fear/Anger/Sad/Happy) index.

56. The system of claim 55 wherein the FASH index is used to form a still further graphical representation of the selected mood state of the person.

57. The system of claim 56 wherein the further graphical representation comprises two sets of balanced arms, with a first arm supporting the fulcrum of a second arm, the first arm being representative of the primary moods “Fear” and “Anger”and the second arm being representative of the primary moods “Happy” and “Sad”.

58. The system of claim 57 wherein when the determined scores for the primary moods “Fear” and “Anger” are the same, the first arm is graphically depicted as evenly balanced and when the determined scores for the primary moods “Happy” and “Sad”are the same, the second arm is graphically depicted as evenly balanced.

59. A computer programme for graphically representing a selected mood state of a person by:
(a) presenting a graphical representation means to the person; and
(b) requesting the person use the graphical representation means to graphically represent the proportion that each of a number of primary moods contributes to the selected mood state.

60. A computer readable medium containing machine-executable programme code for graphically representing a selected mood state of a person, the code, on execution by a computer, resulting in the computer:
(a) presenting a graphical representation means to the person; and
(b) requesting the person use the graphical representation means to graphically represent the proportion that each of a number of primary moods contributes to the selected mood state.
